(19) United States
(12) Patent Application Publication
(10) Pub. No.: US 2010/0235854 A1
(43) Pub. Date: Sep. 16, 2010

(54) Audience Response System

(76) Inventor: Robert Badgett, San Antonio, TX (US)

Correspondence Address: JACKSON WALKER, L.L.P., 112 E. PECAN, SUITE 2400, SAN ANTONIO, TX, 78205, US

(21) Appl. No.: 12/722,518

(22) Filed: Mar. 11, 2010

Related U.S. Application Data
(60) Provisional application No. 61/159,228, filed on Mar. 11, 2009.

(51) Int. Cl. H04N 7/173; G06F 17/27

(52) U.S. Cl. 725/24; 704/9

(57) ABSTRACT

An audience response system (ARS) includes an audience response server, an instructor provided with a terminal, and audience members, either individually or in groups, provided with response devices. The instructor may ask open-ended questions, and students may respond with free-text answers. The audience response server then classifies similar answers based on literal or semantic similarity, so that the instructor can see at a glance which answers may be grouped together. The audience response server may also break answers down into discrete concepts, so that the instructor can see if certain groups correctly identified some concepts, even if the answer is not correct in its entirety.

### CROSS-REFERENCE TO RELATED APPLICATIONS

This application claims priority to and benefit of U.S. Provisional Application 61/159,228, filed Mar. 11, 2009, and titled “Audience Response System.” The foregoing is incorporated herein by reference.

### BACKGROUND

This specification relates to the field of educational aids and more particularly to an audience response system.

An audience response system is a method of gathering audience feedback and measuring progress. For example, in one variation called the “Delphi method,” participants provide anonymous feedback, which is published in aggregate to the group. The initial round may be followed by additional rounds in which groupings are further refined, and a statistical analysis may be performed on the final result.

Audience response systems are also useful in classroom environments to measure progress of the class and assess which concepts need further discussion. For example, an instructor may query students on a key concept to determine which portion of the class can correctly answer.

Most prior-art audience response systems force users to select from multiple-choice answers. By using multiple choice, designers of audience response systems were able to place bounds on the possible results and simplify statistical analysis. But multiple choice also limits the responders' thought process. One approach of dealing with this difficulty has been to allow free text answers. The free-text method has generally suffered from one of two difficulties. Either the instructor will have to carefully plan and enter all possible answers in advance, or the instructor will have to “train” the machine on categorizing certain answers. Such systems, while an improvement on multiple-choice systems, still have some key disadvantages. For example, an instructor cannot respond to the flow of a lecture in real time by introducing questions targeted at particular concerns arising in class.

### SUMMARY OF THE INVENTION

An audience response system (ARS) includes an audience response server, an instructor provided with a terminal, and audience members, either individually or in groups, provided with response devices. The instructor may ask open-ended questions, and students may respond with free-text answers. The audience response server then classifies similar answers based on literal or semantic similarity, so that the instructor can see at a glance which answers may be grouped together. The audience response server may also break answers down into discrete concepts, so that the instructor can see if certain groups correctly identified some concepts, even if the answer is not correct in its entirety.

### BRIEF DESCRIPTION OF THE DRAWINGS

FIG. 1 discloses an embodiment of an audience response system;

FIG. 2 discloses an ARS server with more particularity;

FIG. 3 shows an exemplary output from an ARS server;

FIG. 4 shows an exemplary view of further output from an ARS server;

FIG. 5 shows an additional capability of the present invention;

FIG. 6 shows an additional embodiment of the network of FIG. 1;

FIG. 7 discloses a tactile response device 700 usable in an embodiment of an ARS; and

FIG. 8 discloses an embodiment of the ARS wherein a question and answer can be broken down into a plurality of distinct concepts.

### DETAILED DESCRIPTION OF THE EMBODIMENTS

An audience response system (ARS) according to the present disclosure permits users to enter free text answers and assists the instructor in grouping responses. In one embodiment, the instructor asks an open-ended question and permits users to enter responses into user response devices. The responses are relayed to an audience response system server over a network. Once a sufficient number of responses are received (as determined by the instructor, or as determined automatically by the system), the server groups the responses based on classification criteria. For example, answers may be based on key words, including common misspellings of keywords.

In one example, an instructor asks students to respond with the name of the planet closest to the sun. Based on spelling-correction dictionaries and algorithms, the server may recognize that “Mercury,” “mercury,” “merkury,” and “mercurie” are the same intended answer, and classify them all with “Mercury.” It may also recognize that “Venus,” “vemus,” “venis,” and “venous” are the same intended answer, and classify them with Venus. The server will then tally all of the answers in the “Mercury” class and display a unified total. After similarly processing the “Venus” class, the server will display the rankings of the two answers. Students may then have the opportunity to modify their answers in a second round, until the class has reached a consensus within a certain degree.

In another example, an instructor may ask a class to determine the correct dosage of a medicine given certain parameters, with the correct dosage being 80 micrograms. The ARS may recognize that legitimate abbreviations include “mcg” and “ug.” It may also recognize that rounding errors may result in a small range of answers clustered around 80 micrograms. It may even recognize the raw number “80” as a correct answer, or give the instructor the option to recognize it, if the medicine in question is generally understood to be administered in microgram doses. However, it may reject “80 mg” as a legitimate answer, because even if the student correctly performed the calculation, writing a prescription for 1,000 times the correct dose could be lethal to a patient, even if the calculation was correct in the first instance.

To further refine the educational process, the server can track which students got the actual right answer, which students got a variation of the right answer, which students got a wrong answer that is an actual planet, and which students got a wrong answer that is a variation of an actual planet. This can help the instructor assess both individual needs, and the progress of the class as a whole.

In one embodiment, an audience response server groups semantically similar answers, including identical answers. This will result in few groups of the responses for the instructor to select from and will help the instructor efficiently select correct answers.

The system may also sort answers. In one embodiment, the primary sort order is frequency of occurrence, on the theory that the most common answer is likely to be the correct one. For example, the audience response server may classify answers that correspond to “Mercury,” “Venus,” and “Mars,” in descending order of frequency. The groups of responses would be presented to the instructor in that order under the assumption that Mercury, being the most frequent response, is most likely to be correct.

In some embodiments, the audience response system server may be a web server that receives all responses submitted by participants over a network such as the internet. This may facilitate both local instruction and remote instruction, by enabling remote users to provide feedback. In some embodiments, an audio and video feed (“a/v feed”) of the lecture may be provided to the server, which may stream the a/v feed over the internet to remote users. The remote users can then respond to the lecture in real time. In an alternative embodiment, lectures from a larger audience can be recorded, and time-delayed users may be able to watch and provide feedback, which is correlated with historical data to measure the user's progress. For example, if a user is watching a recorded lecture, he may submit that “venous” is the closest planet to the sun. The web server can add this response to the response array, and the user may then see a response chart plotting all of the previous answers, with his own included in the data.

In an alternative embodiment, the server preprocesses responses before displaying them to the user. For example, preprocessing might allow automated corrections of obvious misspellings or typos. This option may simplify the exercise for the instructor, but should be used judiciously, as many classes deal in jargon specific to the subject matter that may not match standard dictionaries. In that case, spell checking can be hazardous.

In one exemplary embodiment, each student or team of students goes to an entry page for the ARS and submits their responses to questions or tasks posed by the teacher. The instructor has access to a protected entry page for the ARS and can monitor how many teams have submitted answers. Once all of the answers are received, the instructor reveals them all on the instructor's computer that is projected in the classroom. The ARS provides a common technological solution to two disparate problems.

Team-based learning (TBL) is an educational strategy that is receiving increased interest in many fields, including medical education, and is suitable for use with an ARS. TBL can increase student engagement because it emphasizes independent study, assessment of individual and group knowledge, and in-class group assignments. To foster peer teaching, students work in teams to complete the assignments, and answers are revealed simultaneously to foster group and whole-class discussions. An ARS of the present disclosure allows for free-text input in TBL exercises, and permits the identification of which groups entered which responses. In TBL, group accountability is an important feature since this will foster peer interaction.

An exemplary TBL exercise includes instructing groups to write a prescription. This is a complex task requiring identifying the correct medication, calculating dosage, finding dosage strengths and fulfilling all of the requirements of a prescription. From personal experience, students are often able to select a best answer from multiple choice questions, but are unable to write an accurate prescription in practice. But with the ARS of the present disclosure, each group could write a prescription and submit it to the ARS server, allowing the instructor to reveal all answers at the same time. This encourages students to discuss the different answers, and helps the instructor to see which aspects of prescription writing are deficient in the group.

An example that takes further advantage of the ARS is Evidence-based Medicine (EBM). The instructor could ask teams, for example, to find a study to support a clinical position and paste the citation into the ARS. Using the group laptops, the students could access on-line information and then post answers using. This exercise requires high levels of thought as students have to decide on resources and search techniques and identify best articles.

The ARS of the present disclosure also addresses some drawbacks that may be apparent to prior art systems. For example, computers in the classroom may distract learners. Many learners may either have difficulty sharing one computer, or the group process will fragment if they share more than one computer. Furthermore, use of the ARS could be limited by lack of availability of computer lab space. To avoid these problems, the ARS may be implemented with varying group sizes, and audience response devices may include wireless mobile computing devices such as laptops, PDAs, smart phones, or dedicated audience response devices, which may employ any of a number of commonly-known communication protocols, including TCP/IP, RF, IR, and which may in some cases include encryption or other security mechanisms. In one embodiment of the ARS, users interfaces with the ARS through existing web pages sized for desktop and laptop as well as smaller pages that may be sized for PDAs and smart phones. The functionality may also be designed into a minimal interface that can be provided as a browser tool bar. The web pages can be designed to display answers generated by teams in team learning, or by individuals in group decision making.

In order to overcome the obstacle of limited computer lab accessibility, laptops can be used in a traditional classroom setting. By using group instruction, 5 computers may be adequate for a classroom of 30 students, for example. This is a much less expensive model than using a computer lab with 30 computers. In order to minimize technical issues during the study phase, the laptops may be the same model with identical software configurations. In other embodiments, students may provide their own personal laptops, and the instructor or institution may provide suitable software to run on the system.

The disclosed ARS realizes significant advantages. It allows the expansion of team learning into areas such as EBM without the use of expensive computer labs. Furthermore, the creation of a special-purpose laptop cart, containing a small number of identical laptops, locked down physically and in software, may allow the technology to be brought into the traditional classroom without the expense of a large computer lab, and without the distraction of each individual student having a personal laptop computer. It also allows for innovation in teaching medium size classes in all disciplines and would also allow better utilization of the existing computer labs for tasks where each student needs an assigned computer. Another advantage is advances in distance learning. ARS will allow the off-site groups to reveal their answers and to see the answers of the other groups in a more interactive way.

An audience response system will now be described with more particular reference to the attached drawings. Embodiments and examples shown herein are disclosed by way of non-limiting example, and should not be construed as limiting the appended claims.

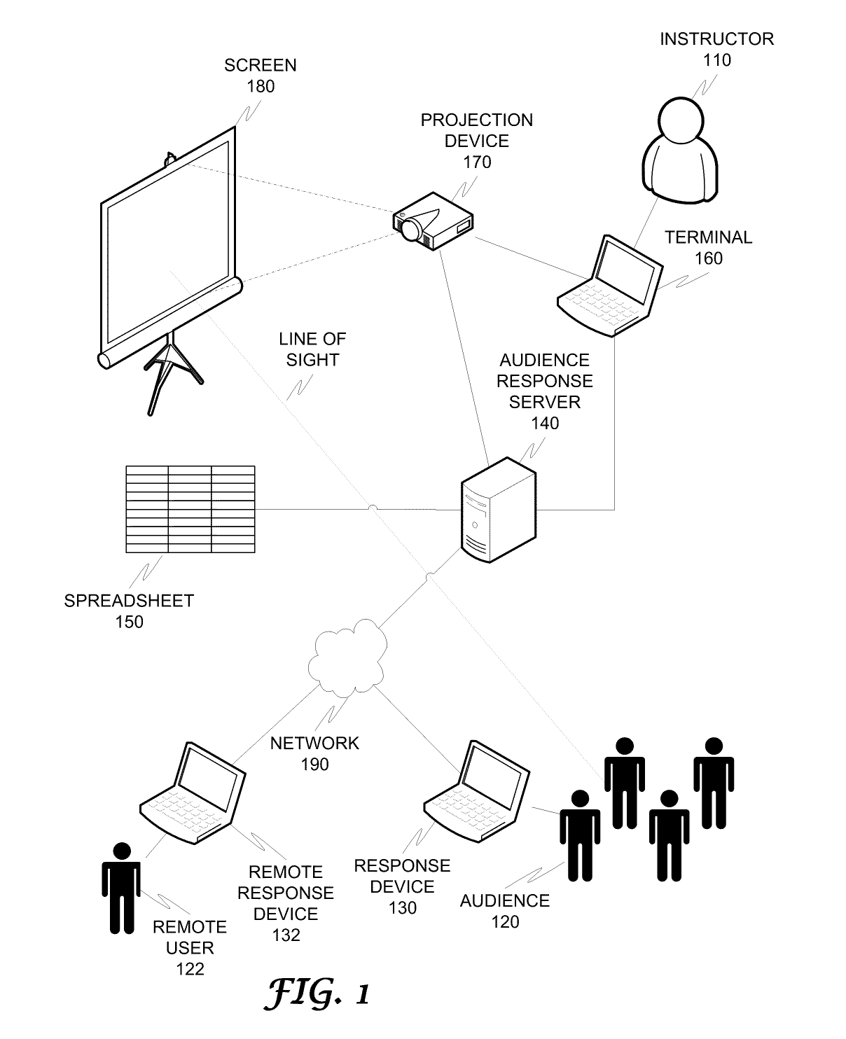

FIG. 1 discloses an embodiment of an audience response system 100. The ARS 100 is operated by ARS server 140. ARS server 140 is programmed to perform the functions as disclosed above. An instructor 110 interacts with a terminal 160, which may be, for example, a laptop computer or other suitable device for interfacing instructor 110 to ARS server 140. In some embodiments, a projection device 170 will be provided, which may receive audio and video data from one or both of ARS server 140 and terminal 160. Projection device 170 may project an image onto screen 180.

An audience 120 is interacting with instructor 110 in person and may have a line of site to screen 180. Members of audience 120 have access to an input device 130, which may be a shared laptop, a personal laptop, PDA, smart phone, or any other suitable device. Response device 130 connects to ARS server through a network 190, which may include the internet. A remote user 122 also has a remote device 132, which allows him to interact with ARS server 140 and thereby participate in exercises. ARS server 140 may provide an a/v stream to user 122 over network 190. In that case, a display on response device 130 may provide a split screen, including a field for entering responses and a field for Finally, ARS server 140 may store results of discussions in a spreadsheet 150 or other useful data storage mechanism.

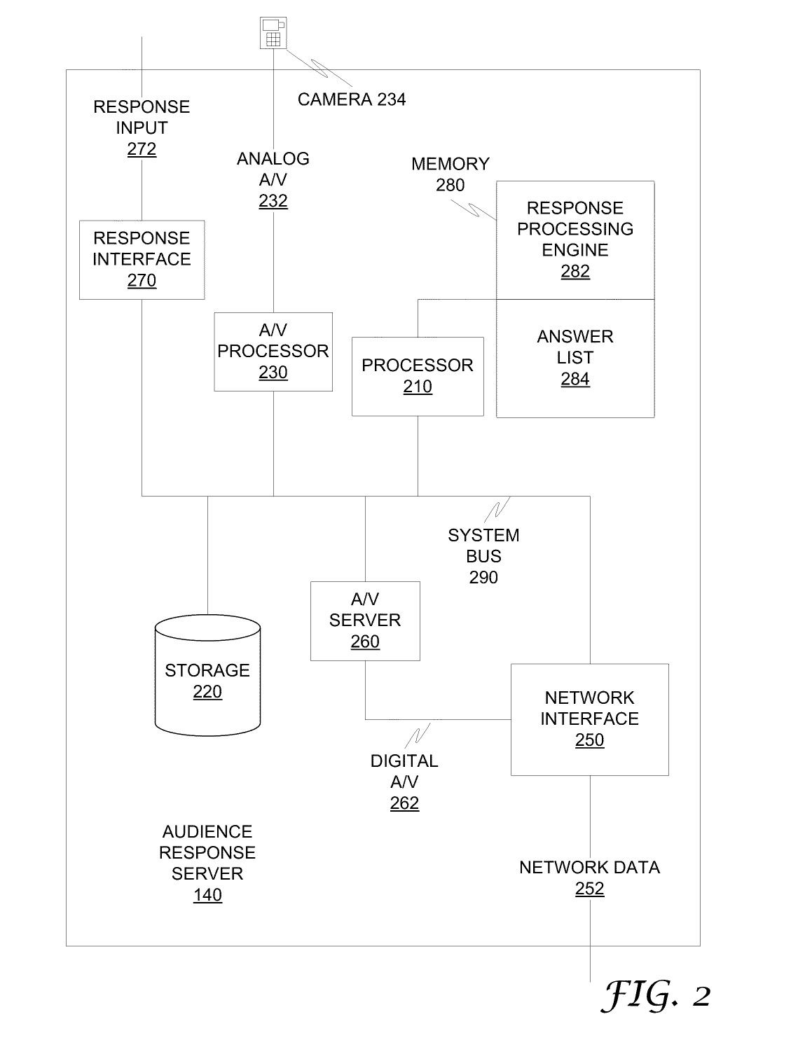

FIG. 2 discloses ARS server 140 with more particularity. ARS server 140 includes a processor 210 providing central control. Processor 210 may be a microprocessor, microcontroller, application-specific integrated circuit, or other logic device capable of executing software or firmware instructions. Processor 210 interacts with other devices over system bus 290. Memory 280 is also attached to processor 210, which may be random access memory (RAM) or other low-latency memory technology suitable for storing instructions for execution. At runtime, memory 280 includes a response processing engine 282 and storage locations for an answer list 284. Response processing engine 282 includes the logic necessary to identify and classify answers. Also connected to system bus 290 is storage 220, which includes non-volatile long-term storage for instructions and data. In some embodiments, storage 220 and memory 280 may be a single physical device.

ARS server 140 also includes a network interface and a response interface. Response interface 270 includes circuitry and logic necessary to receive and process response inputs 272. There is also a network interface 250, which receives circuitry and logic necessary to receive network data 252. Finally, there is a audio/video processor capable of receiving analog a/v data from an analog source such as a camera 234, which may include a microphone. A/v processor 230 digitizes a/v data and provides digital data to a/v server 260, which contains circuitry and logic necessary to send a/v data over the network 190. Note that although response interface 270, a/v processor 230, and network interface 250 are shown separately, these are logical divisions, and do not necessarily imply that each is a separate physical device. For example, in some embodiments, a/v data may be digitized before being provided to ARS server 140, in which case a/v processor may receive digital data over the network, and may include only software instructions that perform the processing functions. And in cases where audience responses are provided as network packets, response interface 270 may be a logical function of network interface 250.

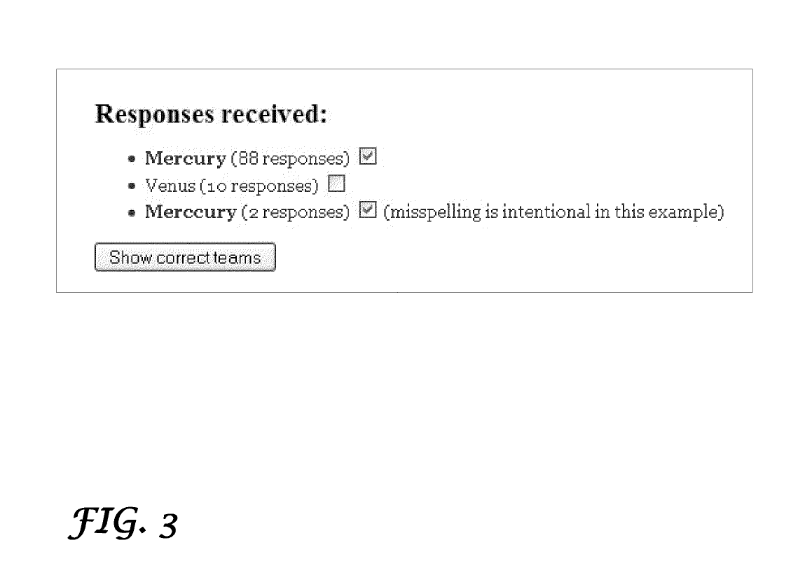

FIG. 3 shown an exemplary output from an ARS server 140. In this case, the instructor may have asked which planet is the closest to the sun. As shown, 88 respondents correctly responded “Mercury.” Ten respondents incorrectly responded “Venus.” Two respondents said “Merccury,” which the software may recognize as an attempt to answer “Mercury.” Because, in this case, the instructor is more interested with the correct recognition of the planet than the particular spelling, he may group the “Merccury” responses with the correct response.

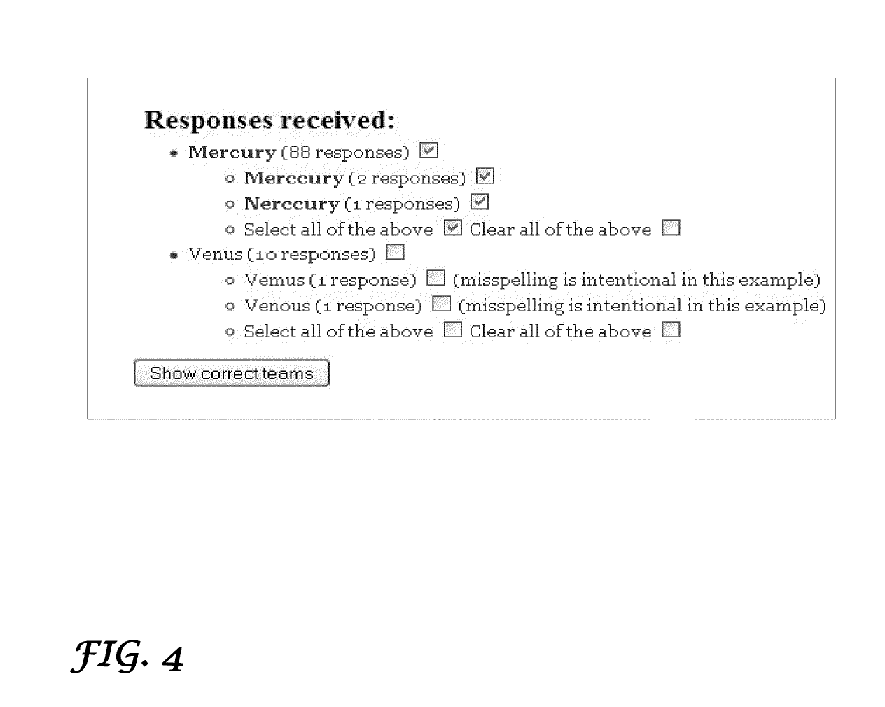

FIG. 4 shows an exemplary view of further output from an ARS server 140. In this case, the answer “Nerccury” is also received from one student (who perhaps is merely a clumsy typist). This response is less readily recognized as an equivalent of “Mercury,” and so the software may classify it with “Mercury” as the closest possibility. But the instructor has the ultimate option of whether to recognize it as a correct response. In this case, if the instructor chose to not recognize “Nerccury,” he could uncheck the selection. It is also seen that “Vemus” and “Venous” were provided as misnomers for “Venus.” The examiner may also have the option of recognizing these as equivalents of “Venus” and so classifying them.

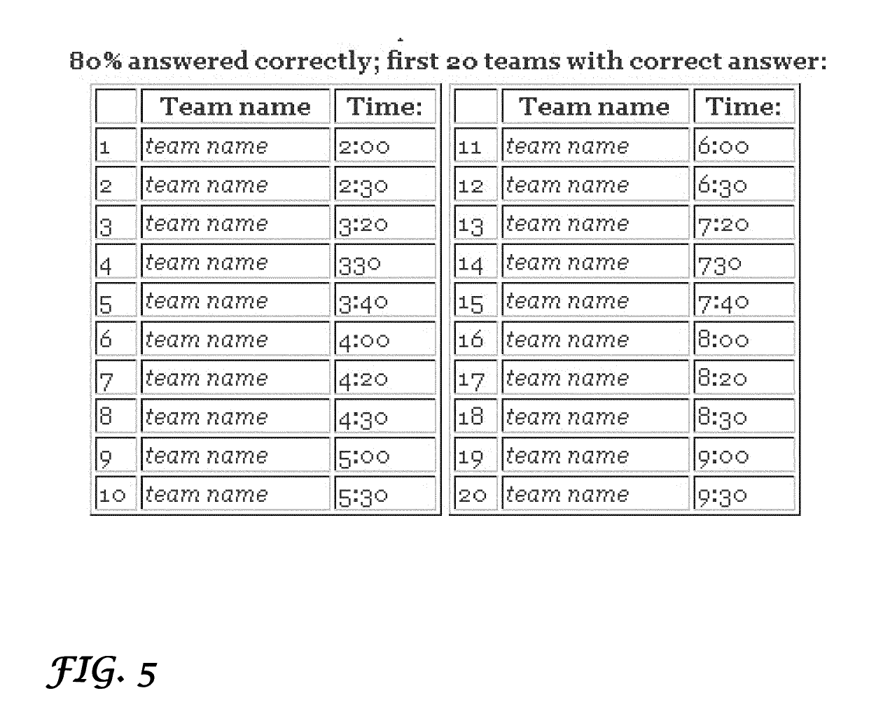

FIG. 5 shows an additional capability of the present invention. In this case, the software recognizes that 80% of respondents correctly answered the questions, which may include answers that were correct in substance but technically problematic (such as misspellings). The software also has the ability to rank the response time of each team, so that the instructor can see which teams were able to correctly respond in a short amount of time, and which arrived at the correct answer, but only after a more extended time.

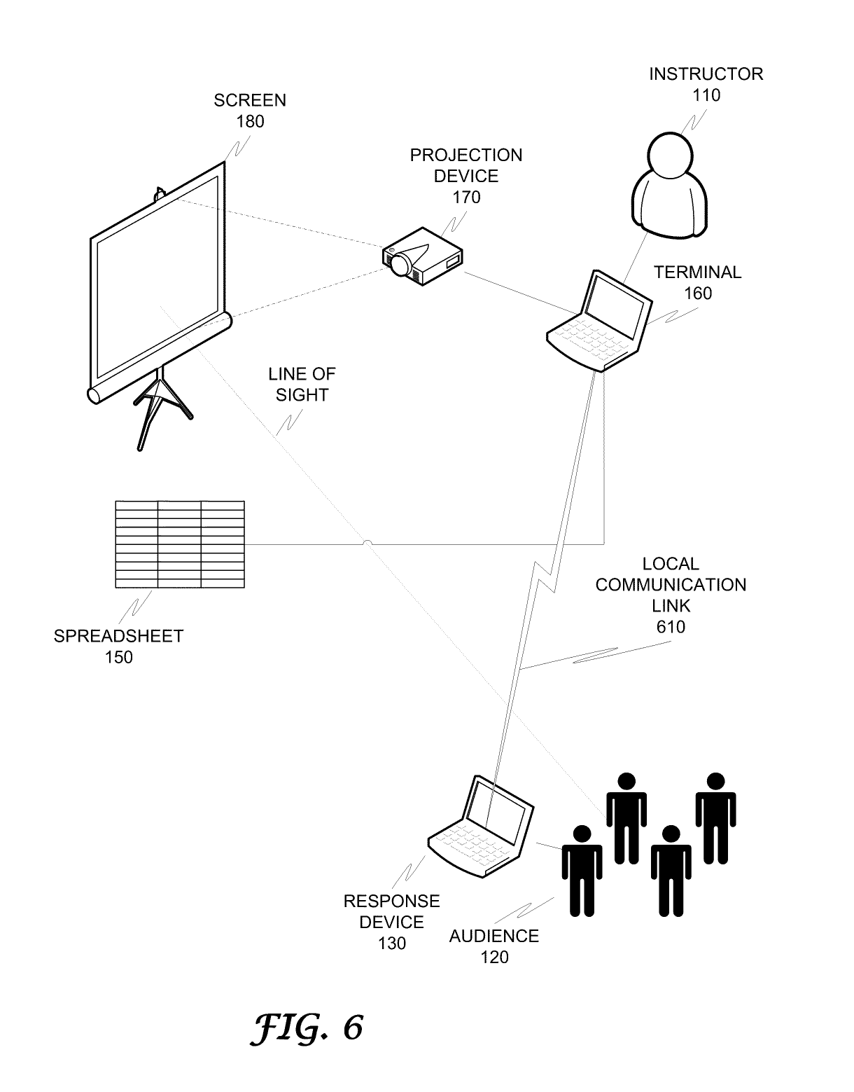

FIG. 6 shows an additional embodiment of the network of FIG. 1 wherein network 190 and related elements are replaced by a single local communication link 610. Local communication link 610 may be provided by infrared, radio frequency, WiFi, or other similar technologies, and may connect audience response device 130 directly to terminal 160. In this embodiment, it may be preferable for the functions of audience response server 140 to be hosted locally on terminal 160 rather than on separate hardware.

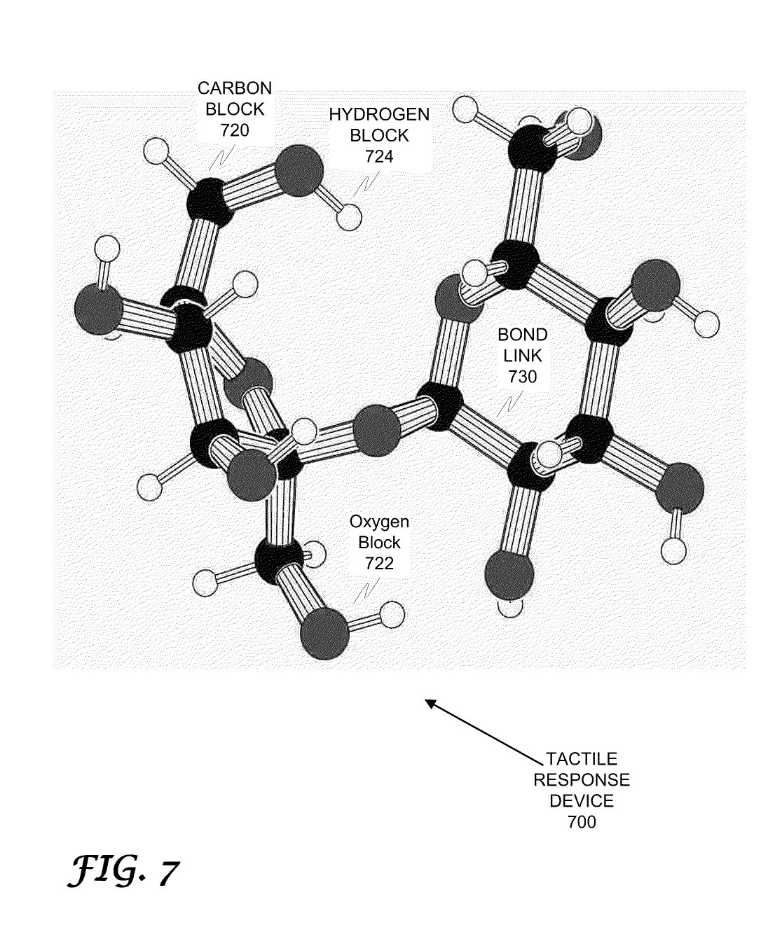

FIG. 7 discloses a tactile response device 700 usable in an embodiment of an ARS. This embodiment demonstrates the versatility of an ARS. This embodiment may be useful, for example, in a chemistry class, and could be used to bring laboratory-type exercises into a lecture environment. Instructor 110 may provide a plurality of groups with one tactile response device 700 each, the tactile response device 700 being used as a species of response device 130. In this case, tactile response device 700 may include a set of blocks that represent types of elemental atoms, as well as different types of bonding links. Instructor 110 may then instruct the groups to each construct from these materials a known molecule, such as sucrose. A correct construction of sucrose will have the right number of carbon, oxygen, and hydrogen atoms, each linked to one another with the proper types of links, and at the proper angles. Students may use carbon blocks 720, oxygen blocks 722, and hydrogen blocks 724 to construct the molecule, and bind each to the others with bond links 730. Using methods known in the art, tactile response device 700 may determine which blocks were used, and how they were arranged and linked. For example, each block and link could have disposed thereon at the point of contact a contact sensor or proximity switch, with encoding to identify the type of block or link. Or each block and link could have disposed therein a remote communication device, such as a radio frequency transceiver, so that each block or link can determine its location relative to the others. Tactile response device 700 may further be configured to communicate with audience response server 140 and provide information about the configuration to instructor 110. The information provided may include such information as the number and type of elements used, the number, type, and arrangement of links used, and the orientation of the elements with respect to each other. The information provided may be sufficient for audience response server 140 to construct a visible 3-dimensional model for viewing by instructor 110.

Other types of tactile response devices may also be used. For example, groups may be provided with a set of planets, and instructed to construct a model of the solar system. Architectural or engineering students may be provided with interlinking structural elements and instructed to build a particular type of structure.

Furthermore, as a tactile response device 700 and response device 130 are disclosed only by way of example, it will be apparent to those with skill in the art that other types of response devices may be adapted for use with an ARS. By way of non-limiting example, the following are possible:
users can provide written responses on table computers or other touch-sensitive devices, whereupon handwriting recognition software may classify textual responses;
users can provide hand-drawn responses on tablet computers or other touch-sensitive devices, whereupon known techniques can be used to analyze important elements of a drawing, for example, a drawing may be analyzed for the use of perspective points and maintenance of vertical lines, or subjects may be given a cognitive task such as drawing a stick figure, and known techniques may be used to classify responses according to the number of discrete body parts drawn;
members of audience 120 may provide verbal answers, and voice recognition software may be used to record responses, which may then be classified as text responses;
portable scanners or intelligent writing implements may be used to capture what is written on paper or a white board, and responses may be classified as described above;
other functionally-equivalent technologies may be developed in the future that are suitable for use in a response device 130.

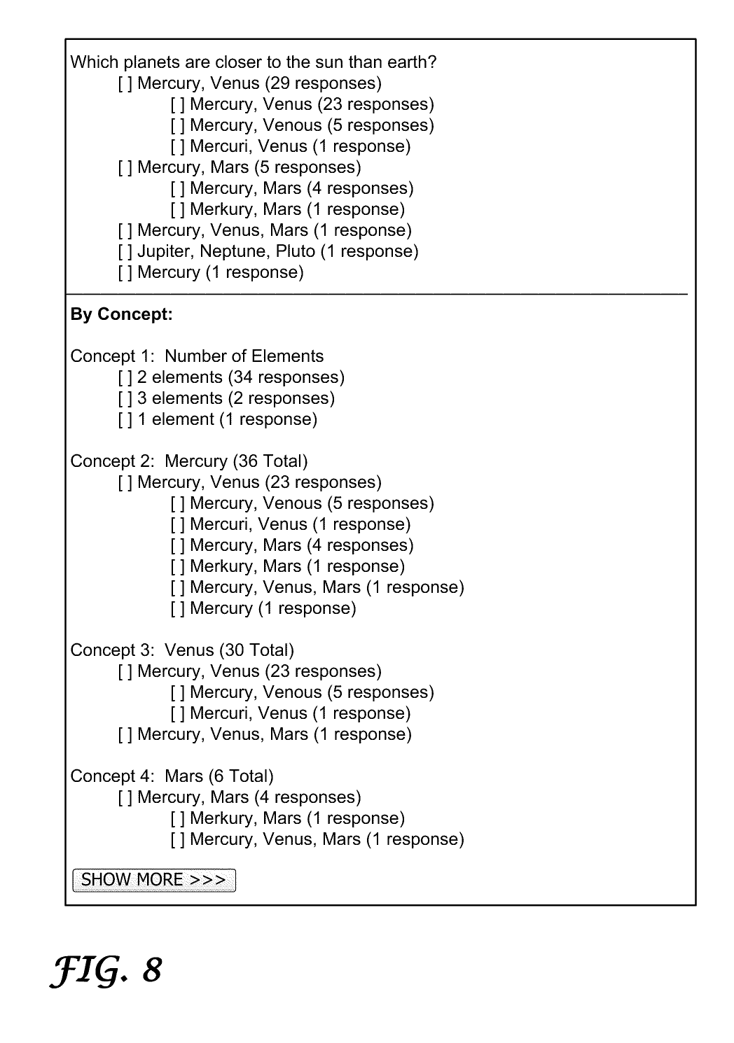

FIG. 8 discloses an embodiment of the ARS wherein a question and answer can be broken down into a plurality of distinct concepts. For example, instructor 110 may ask an open-ended question, such as “Which planets are closer to the sun than earth?” He may then be presented with a user interface that permits him to characterize potential responses according to concepts. In this case, instructor 110 may select to break down responses by the number of elements and by the text of each element. By working with concepts, instructor 110 can assess responses with finer granularity. For example, instructor 110 will be able to see not only that 29 respondents correctly identified Mercury and Venus, but also that 34 respondents knew that there were two planets, even if they didn't correctly identify them, that 36 respondents at least correctly identified Mercury as a planet closer to the sun than the earth, and that 30 respondents correctly identified Venus as a planet closer to the sun than the earth. Instructor 110 can also see that 6 respondents incorrectly identified Mars. With this information, instructor 110 may be able to focus his later instruction to address specific shortfalls gleaned from the responses.

Similar conceptual breakdowns of responses can be used to assess other types of responses discussed above. For example, in the case of asking a correct prescription for a patient, responses may be broken down into drugs prescribed and amount prescribed, and the amount may even be further broken down into the numerical portion of the amount and the units. As there may be more than one drug useful for treating the condition, the instructor can identify groups that prescribed a correct drug, groups that prescribed correct numerical amounts, and groups that prescribed correct units. Advantageously, the instructor may thus be able to see at a glance, for example, if a large number of groups are prescribing 1,000 mg of a drug instead of 1,000 mcg, which may indicate a need to focus on correct units.

Similarly, the instructor who instructs groups to build a sucrose molecule as in FIG. 7 can see at a glance which groups correctly placed the right number of each type of element, the number and type of bonds used, and angles.

One consideration in operating an ARS of the present disclosure is the algorithm used for grouping of responses. There are numerous algorithms known in the art for text-matching. By way of non-limiting example, methods such as the following may be used for matching:
Literal matches—in the simplest forms, responses that are literal matches will be grouped together. For example, two identical occurrences of “Mercury” will be grouped together, or two correctly-constructed sucrose molecules will be matched together.
Spell check—spell check algorithms known in the art, such as those used to operate spell check software, may be used to group near-literal matches. For example, a spell check may recognize that “Merkury” is a semantic match for “Mercury” despite the misspelling. If spelling is not a critical concept for the lesson at hand, then the instructor may elect to equally credit the two responses despite the misspelling. In other cases, where spelling is deemed at least partially important, the instructor may elect to treat “Merkury” as a semantically-correct response, but display it separately from those who provided a completely correct answer. Depending on the field of study, a general spell-check dictionary may suffice, or a specialized or industry-specific dictionary may be used.
Semantic match—In some cases, synonymous words may be acceptable as substitutes for one another. For example, if the question relates to the mythical messenger god rather than the planet, “Hermes” may be an acceptable substitute for “Mercury.” Depending on the field of study, a general thesaurus may suffice, or a specialized or industry-specific thesaurus may be used. If a subject-matter-specific thesaurus is to be used, the instructor may be provided with a process for selecting which subject-matter-specific thesaurus to use from among a plurality of available thesauri.
Set theory—Some responses may be identifiable as a correct genus and/or correct species. For example, if the question relates to the cause of stomach ulcers, “bacteria” may be a correct generic response, while “h. pylori” may be a correct species of bacteria. On the other hand, “e. coli” may represent an incorrect species of bacteria, while “food” would represent an answer in an incorrect genus. A dictionary or database with a specialized data dictionary may be used to provide genus and species information. The genus and species may represent concepts. For example, groups that answer “e. coli” and “bacteria” may both receive credit for identifying bacteria as the source of stomach ulcers, while groups answering “h. pylori” may receive credit for the bacteria concept as well as the concept that h. pylori is the correct bacterium.
Natural Language Processing (NLP)—NLP algorithms are known in the art, and may be used, for example, in search engine to match key words. One aspect of an exemplary NLP algorithm is the removal of “stop words,” so that key words can be isolated. For example, if the instructor asks for planets closer to the sun than earth, responses may include “Mercury and Venus”, “Mercury Venus” and “Mercury, Venus.” Each of these responses could be minimized to the key words “Mercury” and “Venus,” from which the response processing engine can determine that there are two elements to the answer, and can provide text matching on each element. NLP may also be useful if answers are provided as complete sentences. For example, a subject, verb and/or other critical elements can be identified and matched, while “stop words” are ignored.
Translation—In some embodiments, members of the audience may speak different languages. Known translation algorithms may be used to match answers in different languages. For example, if a correct answer to a question about a contributing factor to stomach ulcers includes “stress” (English), “tension” (Spanish) and “druck” (German) may also be clustered in the same grouping.

By way of non-limiting example, pseudocode for grouping answers and isolating concepts from a plurality of responses is disclosed below:

//Pseudocode for ARS. Version 2010-03-11-c
//Lines preceded by slashes are explanatory comments.
//Input:
//A list of text responses
//Note that a response can have more than one concept so can
//... belong to more than one WordGroup
//... belong to more than one ResponseGroup
//For example, if has two concepts, will belong to three response ResponseGroup
//...one ResponseGroup for each concept individually and one ResponseGroup that
contains both responses
//Output:
//Three dimensional table, ResponseGroup, that groups responses that are similar
based on
//...string (word or phrase) matching, semantic similarity, interlingual translation, etc
//The table is sorted in descending order of group size.
//Within each group
//The groupname is taken from the name of the most common member in the group
//Members of the group are the unique Responses and are sorted in descending order
of the frequency of the unique Responses
//Declare this table array now so its contents will persist when later modified in the
function AddToResponseGroups
Declare three dimensional array ResponseGroup( )
//First column is name of each WordGroup whose concept is represented in the
ResFponse
//Second column are the unique Responses within this WordGroup
//Third column is the frequency count of this permutation of concepts
Declare one dimensional dynamic array Response( )
Declare integer R
Place all responses into array Response (R)
R = number of responses
Declare two dimensional dynamic array UniqueResponse( )
// UR will be the number of unique responses
Declare integer UR
For X = 1 to R

For Y= 1 to UR

If Response(X) = UniqueResponse (Y)) then

//This Response is not unique.
//Increment the count of that UniqueResponse

UniqueResponse (X,1) = UniqueResponse (X,1) +1

else

//Append new row to UniqueResponse ( )
UniqueResponse (X+1,0) = Response (X))

//Later second column will hold the concepts
UniqueResposne (X+1,1) = “”

//As this is first we have seen of this response its count is 1!

UniqueResponse (X+1,2) = 1

//Increment the number of UniqueResponse

UW = UW + 1

Next Y

Next X
//Make array Word which will contain all words (or phrases) in all Responses
//Optional: can do same for phrases
//First column is name of Word
//Second column is the count of the Word
Declare one dimensional array Word( )
// W will be the number of words
Declare integer W
For X = 1 to UR

For each word parsed in UniqueResponse (X,0)

//Append the word as new row in array Words
//Increment the number of Words

W = W + 1
Word(W) = word parsed

Next word

Next X
//Make array Unique Word which will contain all unique words (or phrases)
//First column is name of Unique Word
//Second column is the count of the Unique Word
Declare two dimensional dynamic array Unique Word( )
// UW will be the number of unique words
Declare integer UW
For X = 1 to W

For Y = 1 to UW

If Word(X) = UniqueWord(Y)) then

//Increment the count of that word

UniqueWord (Y,1) = UniqueWord (Y,1) +1

else

//Append new row to WordGroups( )
UniqueWord (Y+1,0) = UniqueWord (Y,0)
//As this is a new UniqueResponse, its count is 1!

UniqueWord (Y+1,1) = 1

//Increment the number of Unique Words( )

UW = UW + 1

Next Y

Next X
//Make array WordGroup with contains groups of words that are similar but may vary
due to misspellings and alternate endings
//Optional: can do same for semantically similar words see http://cwl-
projects.cogsci.rpi.edu/msr/
//Optional: can do same for interlingual translations
//First column is the name of the WordGroup
//Second column is value of the UniqueWord in the WordGroup
//Third column is the count of the WordGroup
Declare three dimensional dynamic array WordGroup( )
// WG will be the number of groups of similar words
Declare integer WG
For X = 1 to UW

//Test each unique string for similarity to all other strings using fuzzy string

matching or similar method

For Y = 1 to WG

//EditDistance is a function that calculates Levenshtein distance or

similar metric

If EditDistance(UniqueWord (X,0), UniqueWord (Y,0)) < acceptable

threshold for similarity

// This UniqueWord is similar to current WordGroup
//Add as new row to current word group
//This new entry is part of the current WordGroup
WordGroup(Y,0, RowCount + 1) = WordGroup(Y,0,0)
//Value of this entry is Unique Word(X,0)
WordGroup(Y,1, RowCount + 1) = UniqueWord (X,0)
WordGroup(Y,2, RowCount + 1) = UniqueWord (X,1)
//Increment the total count of all members in this group
WordGroup(Y,2, 0) = WordGroup(Y,2, 0) + UniqueWord (X,1)
Exit For

If Y = UW + 1 //e.g. Unique Word never matched into an existing

WordGroup

// This Unique Word is NOT similar to current group

//Append new sheet to array WordGroup( )

//Increment the number of WordGroups
WG = WG + 1
//For now, the name of this group is Unique Word(Y,0)
WordGroup(WG,0,0) = UniqueWord (X,0)
//Value of the entry is Unique Word(X,0)
WordGroup(WG,1,0) = UniqueWord (X,0)
//Assign its count
WordGroup(WG,1,0) = UniqueWord (X,1)
Next Y

Next X
Sort WordGroup( ) by descending size of each word using WordGroup(WG,2, 0)
Sort group members with in group by descending size
Rename each group name by using the most prevalence member of the group
//Now we have the three dimensional table unique concepts and it is sorted by
frequency.
//To display the responses, we have to first
//...tabulate the concepts in each UniqueResponse and the frequency of each
permutation of concepts in UniqueResponses
//Remember that UR is the number of UniqueResponses
For X = 1 to UR

//First, determine concepts in each UniqueResponse(X)
//Check each WordGroup
//Remember that WG is the number of WordGroups
For Y = 1 to WG

//Within each WordGroup, check each member

Declare MembersCount as the number of members within WordGroup(Y,0,0)

For Z = 1 to MembersCount

//Check each member of each WordGroup

If UniqueResponse(X,0,0) contains WordGroup(Y,Z,0)

//Concatenate WordGroup to column 2 of UniqueResponse

UniqueResponse(X,1,0) = UniqueResponse(X,1,0) + “;” + WordGroup(Y,Z,0)
//Add or append this UniqueResponse to the ResponseGroup that contains only

this one concept

Call AddToResponseGroups(UniqueResponse (X,0,0))
//Does this UniqueResponse have more than one concept?
If UniqueResponse (R,1) contains “;”

//So this Response has more than 1 concept

//Make one dimension array Permutation which contains all permutations of more

than concept

Declare one dimensional dynamic array Permutation ( )
//P = number of permutations
Declare integer P
For ZZ = 1 to P
Call AddToResponseGroups(Permutation(Z))

Next ZZ

Next Z

Next Y

Next X
//Now that all concepts in this response have been determined and concatenated into
column two of Response(R,1)
Sort ResponseGroup ( ) by descending size of each word using ResponseGroup (RG,2,
0)
Sort group members within group by descending size
Rename each ResponseGroup name by using the most prevalen mtember of the group
//Now we have the final three dimensional table of ResponseGroups that is ready to be
displayed for the instructor
//NOT represented in this pseudocode is:
//After the instructor determines the correct answers, each Response ( ) must be
reviewed to determine
//...if its concatenation of concepts in second column of UniqueResponse was
determined as correct by the instructor.
//End
//------------------------------------------------------------------------------------------------------
----
Function AddToResponseGroups(Permutation)
//Purpose: compare the concepts present in this Response to all existing
ResponseGroups
//Input: a concatenation of one or more concepts
//Remember from the top:
//Declare three dimensional array ResponseGroup( )
//First column is name of each WordGroup whose concept is represented in the
Response
//Second column are the unique Responses within this WordGroup
//Third column is the frequency count of this permutation of concepts
// RG will be the number of response groups
Declare integer RG
For X = 1 to RG

If Permutation = ResponseGroup(X,0,0)

//This response belongs to this group
//Increment the total size of this ResponseGroup
ResponseGroup(X,0, 2) = ResponseGroup(X,0, 2) + 1
//...check to see if it is a unique member of the group
For Y = 1 to RowCount

If Response(R,1) = ResponseGroup(X,Y,1)

//So, not a unique member

//Assign the group name for this new member
ResponseGroup(X,0, Y) = ResponseGroup(X,0, 0)
//Place the original Response into column 2
ResponseGroup(X,1, Y) = Permutation
//Increment the number of this responses with this value
ResponseGroup(X,2, Y) = ResponseGroup(X,2, Y) + 1
else
//So, this is a new member of this group
//Append this response to existing response group Z
//Assign the group name for this new member
ResponseGroup(X,0, RowCount + 1) = ResponseGroup(X,0, 0)
//Place the original Response into column 2
ResponseGroup(X,1, RowCount + 1) = Permutation
//Since this is the first we have seen of this member, the size is 1!
ResponseGroup(X,2, RowCount + 1) = 1

Next Y

Else

//Create new ResponseGroup
//Increment the number of ResponseGroups
RG = RG +1

//Create ResponseGroup name in column 1
//...using the concatenation of concepts found in this response
ResponseGroup(X,0,0) = Permutation
//Place the original Permutation into column 2
ResponseGroup(X,1, RowCount + 1) = Permutation
//Since this is the first member of this group, the size is 1!
ResponseGroup(X,2, RowCount + 1) = 1

Next Z
End function

In some embodiments of an ARS, where certain types of questions frequently occur, the instructor's assessment of responses may be eased by providing a response database, including known correct responses. For example, in the case of the sucrose molecule of FIG. 7, a response database of known molecules may be provided so that instructor 110 can indicate to audience response server 140 that the students in the audience are to construct a sucrose molecule. Audience response server 140 can then automatically identify groups that correctly construct a sucrose molecule, groups that correctly use the right number of each element, groups that correctly construct a molecule with the right shape, and groups that correctly construct a molecule with the right type and number of bonds. In another example, instructor 110 may be able to provide a condition, and audience response server 140 may access a database of drugs suitable for treating that condition, so that groups that correctly identify a suitable drug can be automatically identified. The use of a response database maintains the flexibility inherent in an ARS, preserving the ability of the instructor to ask any type of question without previously programming responses, while also providing some automation in handling common questions.

While the subject of this specification has been described in connection with one or more exemplary embodiments, it is not intended to limit the claims to the particular forms set forth. On the contrary, the appended claims are intended to cover such alternatives, modifications and equivalents as may be included within their spirit and scope.

What is claimed is:

1. An audience response server usable in an audience response system, the audience response server comprising:
a processor capable of executing software instructions;
a response interface communicatively coupled to the processor and configured to connect to a plurality of response devices; and
a memory communicatively coupled to the processor, the memory containing software instructions that when executed instruct the processor to:
receive a plurality of free responses on the response interface, the responses being responsive to a query;
assign each response to a response class based on classification criteria; and
display.

2. The audience response server of claim 1 wherein the memory further contains software instructions to sort the response classes based on sorting criteria.

3. The audience response server of claim 2 wherein the sorting criteria include frequency of response.

4. The response server of claim 1 wherein the selection criteria comprise semantic similarity.

5. The audience response server of claim 1 wherein the selection criteria comprise similarity of numerical content.

6. The audience response server of claim 1 wherein the response device is a text input device.

7. The audience response server of claim 1 wherein the response device is a tactile response device.

8. The audience response server of claim 1 herein the response device is a touch-sensitive display.

9. A method of an audience response system providing interactive instruction between an instructor and an audience, the method comprising the steps of:
receiving a query from the instructor;
providing the query to the audience;
receiving from the audience a plurality of free-form responses to the query; and
classifying the plurality of responses into one or more response groups.

10. The method of claim 9 wherein classifying the responses comprises matching responses according to a spell check algorithm.

11. The method of claim 9 wherein classifying the responses comprises matching responses according to semantic similarity.

12. The method of claim 9 wherein classifying the responses comprises matching responses according to a natural language processing algorithm.

13. The method of claim 9 wherein classifying the responses comprises separating the responses into a plurality of discrete concepts, and determining that at least a portion of each response corresponds to at least one discrete concept.

14. The method of claim 9 wherein classifying the responses comprises matching responses of a species with responses of a genus to which the species belongs.

15. The method of claim 9 wherein classifying the responses comprises:
identifying key words in the responses; and
matching key words according to a thesaurus.

16. The method of claim 15 wherein the thesaurus is a subject-matter-specific thesaurus.

17. The method of claim 16 further comprising the steps of:
receiving a subject matter input from the instructor; and
selecting the subject-matter-specific thesaurus from among a plurality of subject-matter-specific thesauri.
